(19) United States
(12) Patent Application Publication
(10) Pub. No.: US 2024/0256773 A1
(43) Pub. Date: Aug. 1, 2024

(54) CONCEPT-LEVEL TEXT EDITING ON PRODUCTIVITY APPLICATIONS

(71) Applicant: Microsoft Technology Licensing, LLC, Redmond, WA (US)

(72) Inventors: Marco Tulio CORREIA RIBEIRO, Seattle, WA (US); Scott LUNDBERG, Seattle, WA (US); Moshe R. LUTZ, Bellevue, WA (US)

(73) Assignee: Microsoft Technology Licensing, LLC, Redmond, WA (US)

(21) Appl. No.: 18/129,750

(22) Filed: Mar. 31, 2023

Related U.S. Application Data
(60) Provisional application No. 63/441,634, filed on Jan. 27, 2023.

(51) Int. Cl. G06F 40/274; G06F 40/137

(52) U.S. Cl. CPC G06F 40/274; G06F 40/137

(57) ABSTRACT

In accordance with examples of the present disclosure, a productivity application provides a concept-level text editing tool that assists users to create a document by generating suggestions of new contents (e.g., an outline or text) of the document while also improving the quality of existing contents of the document. More particularly, the present disclosure teaches the ability to generate an outline by providing step-by-step suggestions of a next outline item, generate text suggestions based on selected outline items, generate new outline item suggestions from selected text, and generate a list of natural language suggestions for an existing outline and/or existing text in the document. It should be appreciated that any implementation or modification to the document or the outline based on the suggestions is vetted by the user.

### CROSS-REFERENCE TO RELATED APPLICATION

This application claims priority to U.S. Provisional Application No. 63/441,634, titled “Concept-Level Text Editing on Productivity Applications,” filed on Jan. 27, 2023, the entire disclosure of which is hereby incorporated by reference in its entirety.

### BACKGROUND

Productivity applications can include a variety of tools and information that facilitate the accomplishment of a variety of tasks related to producing content, including creating and editing content within documents. When creating and editing content, a user may start with a blank page or from an existing document. It is a well-known challenge for users to start creating a document from scratch. Even with some text already written down, the user often experiences a slowdown in continue writing the document in a cohesive and organized manner. Thus, some productivity applications provide text editing tools to help the users to write. However, existing tools are generally limited to helping users with grammar and spelling.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, a productivity application provides a concept-level text editing tool that assists users to create a document by generating suggestions of new contents (e.g., an outline or text) of the document while also improving the quality of existing contents of the document. More particularly, the present disclosure teaches the ability to generate an outline by providing step-by-step suggestions of a next outline item, generate text suggestions based on selected outline items, generate new outline item suggestions from selected text, and generate a list of natural language suggestions for an existing outline and/or existing text in the document. It should be appreciated that any implementation or modification to the document or the outline based on the suggestions is vetted by the user.

Any of the one or more above aspects in combination with any other of the one or more aspects. Any of the one or more aspects as described herein.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of an operating environment in which a concept-level text editing tool may be implemented in accordance with examples of the present disclosure;

FIGS. 2A-2C depict a flowchart of an example method of generating new outline item suggestions for an outline to be used to create a document in accordance with examples of the present disclosure—auto complete outlines;

FIG. 3A-3C depict a flowchart of an example method of generating text suggestions that correspond to one or more outline items in accordance with examples of the present disclosure;

FIGS. 4A and 4B depict a flowchart of an example method of generating outline item suggestions that correspond to one or more text blocks in a document in accordance with examples of the present disclosure;

FIG. 5 depict a flowchart of an example method of generating outline suggestions for improving an existing outline in accordance with examples of the present disclosure;

FIG. 6 depict a flowchart of an example method of generating document suggestions for improving an existing document in accordance with examples of the present disclosure;

FIGS. 7A and 7B illustrate overviews of an example generative machine learning model that may be used in accordance with examples of the present disclosure;

FIG. 8 is a block diagram illustrating example physical components of a computing device with which aspects of the disclosure may be practiced;

FIG. 9 is a simplified block diagram of a computing device with which aspects of the present disclosure may be practiced; and

FIG. 10 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Productivity applications can include a variety of tools and information that facilitate the accomplishment of a variety of tasks related to producing content, including creating and editing content within documents. When creating and editing content, a user may start with a blank page or from an existing document. It is a well-known challenge for users to start creating a document from scratch. Even with some text already written down, the user often experiences a slowdown in continue writing the document in a cohesive and organized manner. Thus, some productivity applications provide text editing tools to help the users to write. However, existing tools are generally limited to helping users with grammar and spelling.

In accordance with examples of the present disclosure, a productivity application provides a concept-level text editing tool that assists users to create a document by generating suggestions of new contents (e.g., an outline or text) of the document while also improving the quality of existing contents of the document. More particularly, the present disclosure teaches the ability to generate an outline by providing step-by-step suggestions of a next outline item, generate text suggestions based on selected outline items, generate new outline item suggestions from selected text, and generate a list of natural language suggestions for an existing outline and/or existing text in the document. It should be appreciated that any implementation or modification to the document or outline based on the suggestions is vetted by the user.

It should be appreciated that the term “outline” in the present application is a hierarchical way to visually organize ideas and topics in a logical sequence for creating a document. Each outline item of the outline may represent an idea. The term “outline” in the present application is not a mere display of all the text in a document broken down based on a format of the text (e.g., a heading level, which defines a particular set of formats applied to text including a font, a font size, a font color, a paragraph alignment, a line and paragraph spacing, and the like) as appear in the document.

It should be appreciated that although, for exemplarily purposes, described embodiments generally relate to productivity applications, and more particularly, word processing applications, the present methods and systems are not so limited. For example, the concept-level text editing tool described herein may also provide text editing in applications other than word processing applications, such as notebook applications, presentation applications, spreadsheet applications, email applications, instant messaging or chat applications, social networking platforms, and the like.

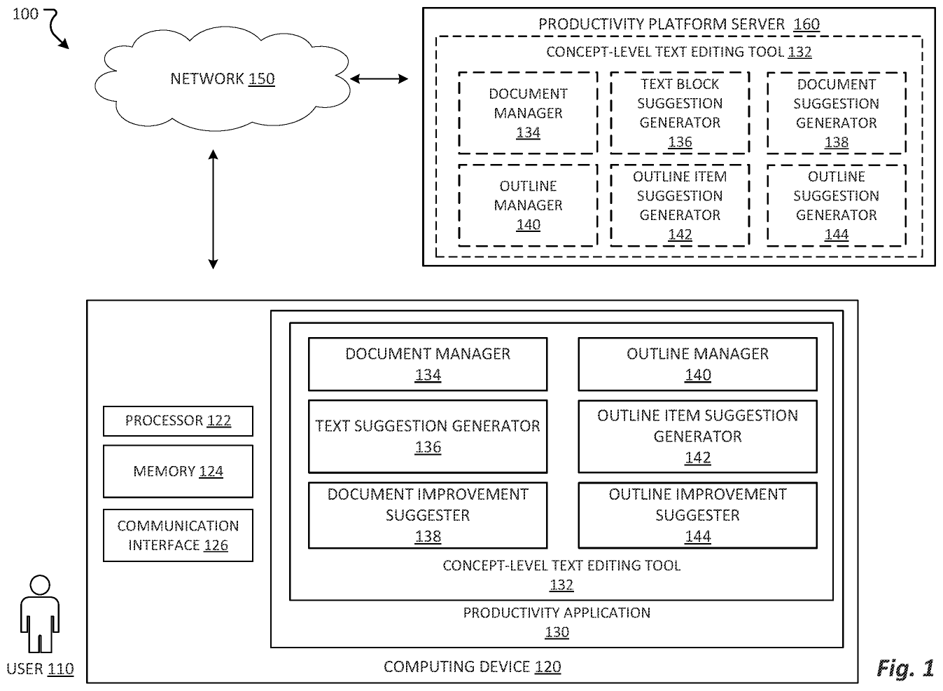

FIG. 1 depicts a block diagram of an example of an operating environment 90 in which a concept-level text editing tool may be implemented in accordance with examples of the present disclosure. To do so, the operating environment 90 includes a computing device 120 associated with the user 100. The operating environment 90 may further include one or more remote devices, such as a productivity platform server 160, that are communicatively coupled to the computing device 120 via a network 150. The network 150 may include any kind of computing network including, without limitation, a wired or wireless local area network (LAN), a wired or wireless wide area network (WAN), and/or the Internet.

The computing device 120 includes a productivity application 130 executing on a computing device 120 having a processor 122, a memory 124, and a communication interface 126. The productivity application 130 allows the user 100 to create a document. For example, the productivity application 130 may be a word processing application, such as Microsoft® Word®. However, in some aspects, the productivity application 130 may be a notebook application, a presentation application, a spreadsheet application, an email application, an instant messaging or chat application, a social networking application, or any other application capable of creating text.

The productivity application 130 includes a concept-level text editing tool 132 that is configured to assist the user 100 to create a document by generating suggestions of new contents (e.g., an outline or text) of the document while also improving the quality of existing contents of the document. More particularly, the concept-level text editing tool 132 is configured to generate an outline by providing step-by-step suggestions of a next outline item, generate text suggestions based on selected outline items, generate new outline item suggestions from selected text, and generate a list of natural language suggestions for an existing outline and/or existing text in the document. To do so, the concept-level text editing tool 132 includes a document manager 134, a text suggestion generator 136, a document improvement suggester 138, an outline manager 140, an outline item suggestion generator 142, and an outline improvement suggester 144.

The document manager 134 is configured to manage one or more text blocks in a document. The text block may include one or more sentences or one or more paragraphs. For example, the document manager 134 is configured to receive one or more text blocks from a user. The document manager 134 is further configured to update the document based on text suggestions for new text blocks or suggested modifications to existing text blocks, which are generated by the text suggestion generator 136 and/or the document improvement suggester 138. For example, the document manager 134 may be configured to add one or more new text blocks, delete one or more existing text blocks, rearrange one or more existing text blocks, and make edits to one or more existing text blocks. It should be appreciated that any implementation or modification to the document by the document manager 134 based on the text suggestions or suggested modifications is vetted by the user.

To do so, the document manager 134 is configured to detect a user intent to generate a text block based on one or more outline items in an outline. To detect a user intent to generate a text block, the document manager 134 may be configured to detect movement of a cursor between an outline panel and a text panel of the productivity application 130 to determine which outline item(s) the user intent to instantiate into text in a document. It should be appreciated that the text panel is adapted to receive and display the text blocks of the document, while the outline panel is adapted to receive and display the outline items of the outline. For example, the document manager 134 may be configured to determine that the user intends to generate a text block that corresponds to a particular outline item if the cursor moves from the outline panel to the text panel and back to a particular outline item in the outline panel. In some aspects, the user may select multiple outline items and move the cursor over the selected multiple outline items in the outline panel to trigger generation of a text suggestion for the selected multiple outline items in the text panel. Additionally, or alternatively, the user may use a short-key for generating the text suggestions. It should be appreciated that, in some aspects, the document manager 134 may be further configured to extract the user intent from speech or voice of the user. Upon detecting the user intent to generate a text block, the document manager 134 is further configured to communicate with the text suggestion generator 136 to trigger generation of the text block, which is described further below.

Additionally, the document manager 134 is further configured to receive a request from a user to improve an existing document. It should be appreciated that, in some aspects, the user may request to improve a part of the existing document by selecting one or more text blocks in the existing document. In some aspect, the user may request to shorten or expand the existing document. It should be appreciated that, in some aspects, the document manager 134 may be further configured to extract the user request from speech or voice of the user. Upon receiving the user request to improve the existing document, the document manager 134 is further configured to communicate with the document improvement suggester 138 to trigger generation of suggestions for improvement, which is described further below.

The text suggestion generator 136 is configured to generate a text block of a document by generating text block suggestions for the new text block based on one or more outline items selected by the user. For example, the text suggestion generator 136 is configured to instantiate the one or more selected outline items into one or more text suggestions using one or more semantic language models (e.g., a semantic embedding model, a generative large language model, a machine-learning model, etc.). The text suggestion may be one or more sentences or one or more paragraphs. For example, when the user moves the cursor from the outline panel to the text panel and back to a particular outline item in the outline panel, and the text suggestion generator 136 is configured to provide a text suggestion based on where the cursor falls in the outline. In some aspects, the user may select multiple outline items and move the cursor over the selected multiple outline items, and the text suggestion generator 136 is configured to provide a text suggestion for the selected multiple outline items.

The text suggestion generator 136 is further configured to provide the text suggestion to the user at the appropriate place in the text panel on a graphical user interface of the user's computing device 120. In some aspects, the text suggestion generator 136 may be configured to identify (e.g., shown in a different color or highlight) the one or more outline items in the outline panel that correspond to the text suggestion while the text suggestion is being presented to the user. Further, the text suggestion generator 136 may be configured to identify (e.g., shown in a different color or highlight) a particular text block in the text panel if the user moves a cursor to one or more outline items that correspond to the particular text block.

Additionally, the text suggestion generator 136 is configured to receive an indication that the user accepts the text suggestion that corresponds to the one or more selected outline items. It should be appreciated that, in some aspects, the text suggestion generator 136 may be configured to provide multiple text suggestions for the selected outline item(s). In such aspects, the user may select a text suggestion from the multiple text suggestions to be written in the document. The text suggestion generator 136 is further configured to communicate with the document manager 134 to update the document to add the new text block from the new text suggestion accepted by the user. Moreover, the text suggestion generator 136 is configured to automatically generate one or more suggestions for a next new text block succeeding the new text block based on the updated document and the existing outline.

The document improvement suggester 138 is configured to generate a list of natural language suggestions for an existing document to improve the quality of the existing outline associated with the document. Specifically, the document improvement suggester 138 is configured to generate one or more document suggestions in natural language based on the existing document using one or more semantic language models (e.g., a semantic embedding model, a generative large language model, a machine-learning model, etc.). Specifically, the document suggestions describe how to improve the existing document in natural language without showing actual suggested modifications to the existing document. For example, the document suggestions may include “use more active verbs” or “vary sentence lengths to create a more engaging rhythm.” The document improvement suggester 138 is configured to provide the one or more natural language document suggestions to the user.

Additionally, the document improvement suggester 138 is configured to generate a preview of suggested modifications to the existing document at the appropriate place in a text panel based on the document suggestion selected by the user. For example, the suggested modifications may include addition of one or more new text blocks, deletion of one or more existing text blocks, rearrangement of the existing text blocks, and one or more edits to the existing text blocks. To do so, the document improvement suggester 138 may be configured to provide all the suggested modifications to the existing document with track changes in the document panel to allow the user to review and vet each of the suggested modifications.

Moreover, the document improvement suggester 138 is configured to receive an indication that the user accepts the one or more suggested modifications to the existing document. The document improvement suggester 138 is further configured to communicate with the document manager 134 to update the existing document to implement the one or more suggested modifications vetted by the user. If the document improvement suggester 138 determines that there is an existing outline that corresponds to the document, the document improvement suggester 138 may be further configured to generate a preview of suggested modifications to the existing outline to reflect changes to the existing document.

The outline manager 140 is configured to manage one or more outline items in an outline. As described above, the term “outline” in the present application is a hierarchical way to visually organize ideas and topics in a logical sequence for creating a document. Each outline item of the outline may represent an idea. It should be appreciated that the term “outline” in the present application is not a mere display of all the text in a document broken down based on a format of the text (e.g., a heading level, which defines a particular set of formats applied to text including a font, a font size, a font color, a paragraph alignment, a line and paragraph spacing, and the like) as appear in the document.

The outline manager 140 is further configured to update the outline based on outline item suggestions for new outline items or suggested modifications to existing outline items, which are generated by the outline item suggestion generator 142 and/or the outline improvement suggester 144. For example, the outline manager 140 may be configured to add one or more new outline items, delete one or more existing outline items, rearrange one or more existing outline items, and make edits to one or more existing outline items. It should be appreciated that any implementation or modification to the outline by the outline manager 140 based on the outline item suggestions or suggested modifications is vetted by the user.

To do so, the outline manager 140 is configured to receive an initial text, additional context data relevant to the document, and/or one or more outline item from the user via the outline or text panel. The initial text may one or more words or phrases, one or more sentences, or one or more paragraphs related to the topic of the document. The context data may include a description of the purpose of creating the document, a description of a preferred writing style (e.g., a writing point of view, a writing tense, a stylistic tone, word and phrasing choices, a type of the document, and the like). In some aspects, the user may indicate that the user wants to emulate a writing style of another author or a style of a certain show. Additionally, the context data may further include description of objects, settings, and characters in a scene of a story that the user wants to write. In other words, the context data may include any information relevant to the user's intent or vision for creating the document. It should be appreciated that, in some aspects, the outline manager 140 may be further configured to extract an user input (e.g., an initial text, additional context data relevant to the document, and/or one or more outline item) from speech or voice of the user.

In other example, the user may describe in a similar fashion an outline of a story, chapter, or scene, which may utilize the settings, objects, and/or characters stored in the context data. This allows the productivity application 130 to generate the full scene from this description. The outline of a story, for example, is there to make it easier for the user to follow changes and updates to the story without having to read every word in a fully generated output.

Additionally, while creating a story outline, the outline manager 140 may be configured to extract settings, objects, and/or characters from the story, and the appropriate description and store as the context data. The context data is accessible and may be modified by the user. Such modifications may then in turn possibly influence the story outline. For example, if a character is modified to have no legs, the story outline may be updated to change or explain the part where that character runs a marathon.

In some aspects, the context data may further include any supplemental information that may be required to generate the document but may not be generally available or accessible to the public (e.g., information internal to a company, like an internal project or codename). It should be appreciated that such context data may be used to train the one or more semantic language models.

It should be appreciated that, in some aspects, the outline manager 140 may generate a context template or object for the context data that may be used and applied in creating another outline or document. For example, a context template may be generated with context data including information internal to a company and may be applied when generating internal documents.

The outline manager 140 is further configured to detect a user intent to generate a new outline item based on the initial text. To detect a user intent to generate a new outline item, the outline manager 140 may be configured to detect a position of a cursor in an outline panel to determine which outline level item the user intent to generate. For example, the user may initiate an outline view and move a cursor to an outline panel to trigger generation of a new outline item. In some aspects, the user may use a short-key for opening the outline panel and initiating the one or more new outline item suggestions. It should be appreciated that, in some aspects, the outline manager 140 may be further configured to extract the user intent from speech or voice of the user. Upon detecting the user intent to generate an outline item, the outline manager 140 is further configured to communicate with the outline item suggestion generator 142 to trigger generation of the outline item, which is described further below.

Additionally, the outline manager 140 is further configured to receive a request from user to improve the existing outline. It should be appreciated that, in some aspects, the user may request to improve a part of the existing outline by selecting one or more outline items in the existing outline. In some aspect, the user may request to shorten or expand the existing outline. It should be appreciated that, in some aspects, the outline manager 140 may be further configured to extract an user request from speech or voice of the user. Upon receiving the user request to improve the existing document, the outline manager 140 is further configured to communicate with the outline improvement suggester 144 to trigger generation of suggestions for improvement, which is described further below.

The outline item suggestion generator 142 is configured to generate outline item suggestions for a new outline item using one or more semantic language models (e.g., a semantic embedding model, a generative large language model, a machine-learning model, etc.). For example, the outline item suggestion generator 142 may be configured to generate outline item suggestions for a new outline item from scratch with minimal information about a document that the user wishes to create. For example, as described above, the minimal information may include an initial text (e.g., one or more words, one or more phrases, one or more sentences, or one or more paragraphs) related to a topic of the document. Additionally, in some aspects, the outline item suggestion generator 142 may be configured to generate outline item suggestions for a new outline item based on context data, which describes a purpose of creating the document, a description of a preferred writing style (e.g., a writing point of view, a writing tense, a stylistic tone, word and phrasing choices, a type of the document, and the like). Additionally, the context data may further include description of objects, settings, and characters in a scene of a story that the user wants to write. In other words, the context data may include any information relevant to the user's intent or vision for creating the document. It should be appreciated that the context data may be useful when using one or more semantic language models because the context data may provide information that may not have been existed before (e.g., a new character for a story that the user is creating in the present outline or document) and/or may not be otherwise accessible (e.g., information internal to a company, like an internal project or codename).

To do so, the outline item suggestion generator 142 is configured to generate one or more suggestions for a new outline item based on the initial text and any existing outline items using one or more semantic language models (e.g., a semantic embedding model, a generative large language model, a machine-learning model, etc.). The outline item suggestion generator 142 is configured to provide the one or more new outline item suggestions at the appropriate place in an outline panel on a graphical user interface of the user's computing device 120. In some aspects, the outline item suggestion generator 142 may be configured to identify (e.g., shown in a different color or highlight) the one or more new outline item suggestions in the outline panel.

In other example, the outline item suggestion generator 142 may be configured to generate outline item suggestions for a new outline item that corresponds to a text block based on existing text block in a document and any existing outline items using one or more semantic language models (e.g., a semantic embedding model, a generative large language model, a machine-learning model, etc.). The outline item suggestion generator 142 is further configured to provide the one or more new outline item suggestions at the appropriate place in the outline panel. The outline item suggestion generator 142 may be configured to identify (e.g., shown in a different color or highlight) the corresponding text block in the text panel when presenting the outline item suggestions to the user.

Additionally, the outline item suggestion generator 142 is configured to receive a user selection of a new outline item suggestion from the one or more new outline item suggestions. The outline item suggestion generator 142 is further configured to communicate with the outline manager 140 to update the outline to add the new outline item from the selected new outline item suggestion. Additionally, the outline item suggestion generator 142 is configured to automatically generate one or more suggestions for a next new outline item succeeding the new outline item based on the updated outline and the existing text in the document.

The outline improvement suggester 144 is configured to generate a list of suggestions for an existing outline in natural language to improve the quality of existing outline. Specifically, the outline improvement suggester 144 is configured to generate one or more outline suggestions in natural language based on the existing outline using one or more semantic language models (e.g., a semantic embedding model, a generative large language model, a machine-learning model, etc.). The outline suggestions describe how to improve the existing outline in natural language without showing actual suggested modifications to the existing outline. For example, the outline suggestions may include “use more active verbs” or “add a call to action to the end.” The productivity application 130 is further configured to provide the one or more natural language outline suggestions to the user and receive a user selection of one of the natural language outline suggestions.

Additionally, the outline improvement suggester 144 is configured to generate a preview of suggested modifications to the existing outline at the appropriate place in an outline panel based on the selected outline suggestion. For example, the suggested modifications may include addition of one or more new outline items, deletion of one or more existing outline items, rearrangement of the existing outline items, and one or more edits to the existing outline items. To do so, the outline improvement suggester 144 may be configured to provide all the suggested modifications to the existing outline with track changes in the outline panel to allow the user to review and vet each of the suggested modifications.

The outline improvement suggester 144 is configured to receive an indication that the user accepts the one or more suggested modifications to the existing outline. The outline improvement suggester 144 is further configured to communicate with the text suggestion generator 136 to update the existing outline to implement the one or more suggested modifications vetted by the user. If the outline improvement suggester 144 determines that there is an existing document that corresponds to the existing outline, the outline improvement suggester 144 may be further configured to generate a preview of suggested modifications to the existing document to reflect changes to the existing outline.

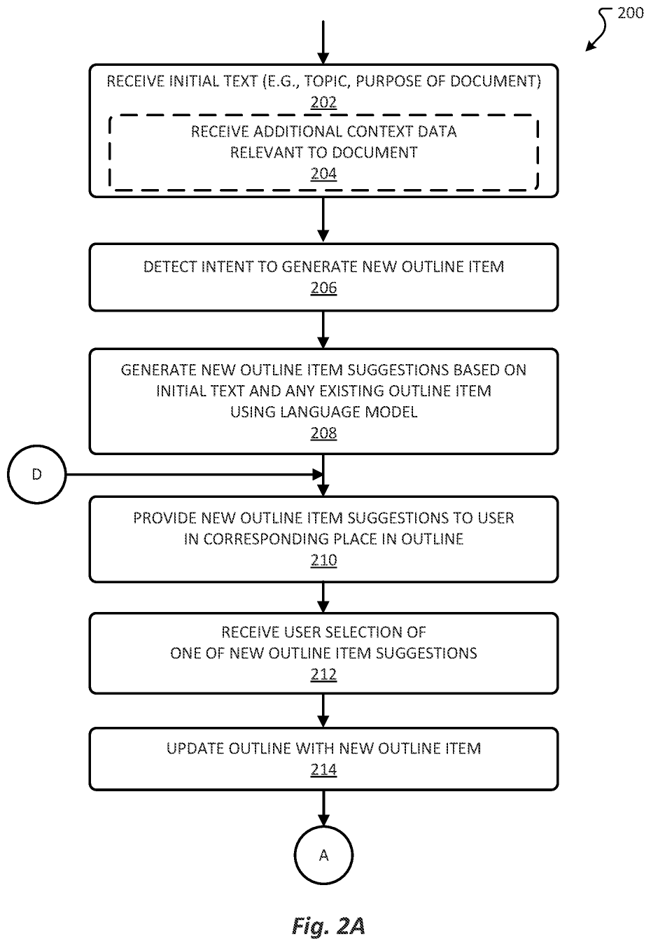

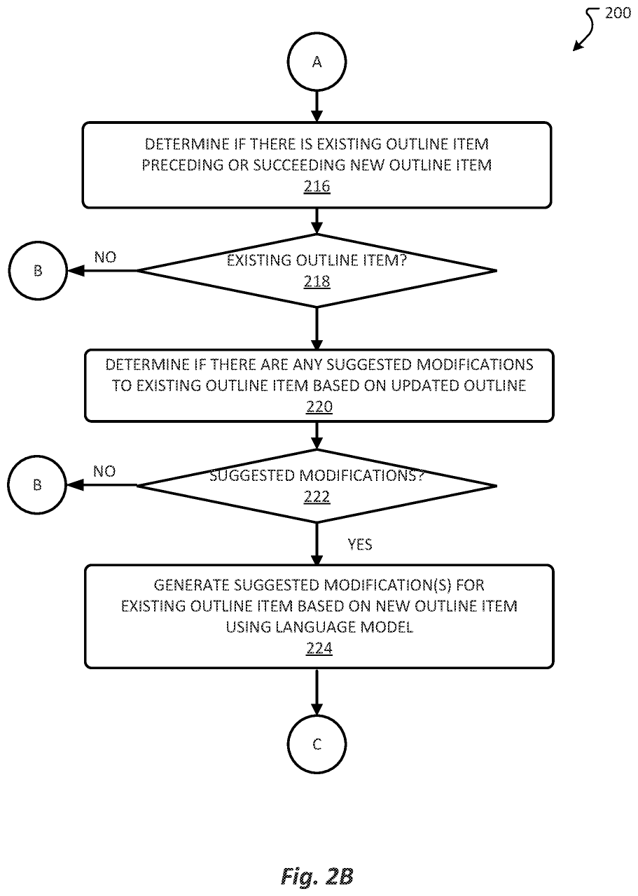

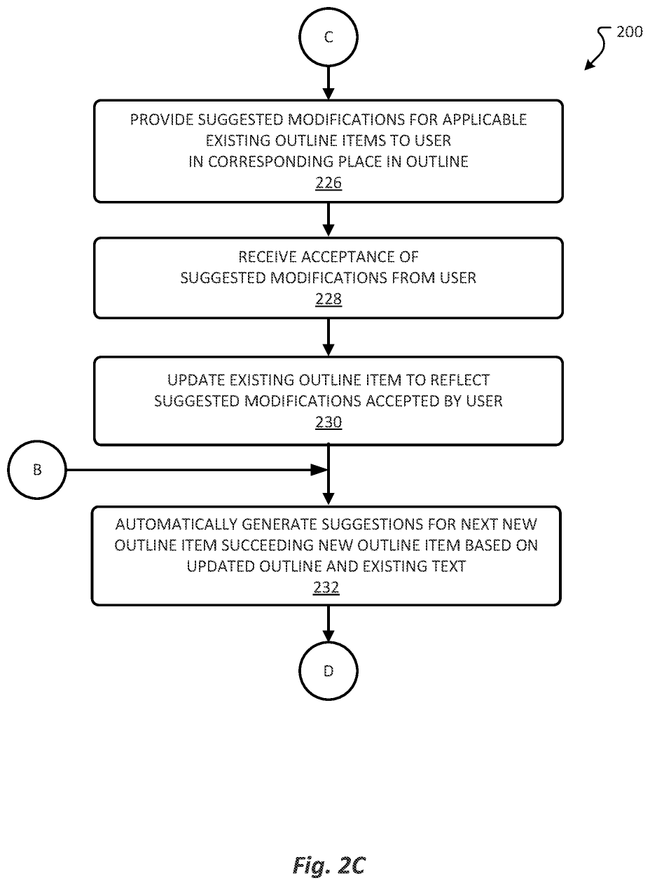

Referring now to FIGS. 2A-2C, a method 200 for generating new outline item suggestions for an outline to be used to create a document in accordance with examples of the present disclosure is provided. A general order for the steps of the method 200 is shown in FIGS. 2A-2C. Generally, the method 200 starts at 202. The method 200 may include more or fewer steps or may arrange the order of the steps differently than those shown in FIGS. 2A-2C. In the illustrative aspect, the method 200 is performed by a computing device (e.g., a user device 120) of a user 100. However, it should be appreciated that one or more steps of the method 200 may be performed by another device (e.g., a server 160).

Specifically, in some aspects, the method 200 may be performed by a productivity application (e.g., 130) executed on the user device 120. For example, the productivity application 130 may be Microsoft® Word® or any other productivity application executed on the computing device 120. More specifically, the method 200 may be performed by a concept-level text editing tool (e.g., 132) of a productivity application (e.g., 130) executed on the user device 120. For example, the computing device 120 may be, but is not limited to, a computer, a notebook, a laptop, a mobile device, a smartphone, a tablet, wearable, or any other suitable computing device that is capable of executing a productivity application (e.g., 130). For example, the server 160 may be any suitable computing device that is capable of communicating with the computing device 120. The method 200 can be executed as a set of computer-executable instructions executed by a computer system and encoded or stored on a computer readable medium. Further, the method 200 can be performed by gates or circuits associated with a processor, Application Specific Integrated Circuit (ASIC), a field programmable gate array (FPGA), a system on chip (SOC), or other hardware device. Hereinafter, the method 200 shall be explained with reference to the systems, components, modules, software, data structures, user interfaces, etc. described in conjunction with FIG. 1 and FIGS. 7-10.

The method 200 starts at 202, where the productivity application 130 receives initial text in a document from a user. The initial text may be related to a topic of the document. For example, when the user opens a new blank document, the user may start with a title of the document that the user wants to create. The initial text may be one or more words or phrases, one or more sentences, or one or more paragraphs related to the topic of the document.

Additionally, at 204, the productivity application 130 may further receive additional context data relevant to the document. For example, the context data may include a description of the purpose of creating the document, a description of a preferred writing style (e.g., a writing point of view, a writing tense, a stylistic tone, word and phrasing choices, a type of the document, and the like). In some aspects, the user may indicate that the user wants to emulate a writing style of another author or a style of a certain show. Additionally, the context data may further include description of objects, settings, and characters in a scene of a story that the user wants to write. In other words, the context data may include any information relevant to the user's intent or vision for creating the document. In some aspects, the context data may be stored as a context template, which can be applied to the present document.

At 206, the productivity application 130 detects a user intent to generate a new outline item. For example, the user may initiate an outline view and move a cursor to an outline panel. Specifically, the productivity application 130 detects the position of the cursor in the outline panel to determine which outline level item the user intent to generate. As described above, the term “outline” in the present application is not a display of all the text in a document broken down based on a format of the text (e.g., a heading level, which defines a particular set of formats applied to text including a font, a font size, a font color, a paragraph alignment, a line and paragraph spacing, and the like) as appear in the document. Likewise, the outline level is not based on the style or format of the text (e.g., the heading level) as appears in the document.

For example, if there are no existing outline items, the presence of the cursor in the outline panel may trigger generation of one or more suggestions for a new first outline item based on the initial text. In other example, the user may initiate the outline view and provide one or more outline items in the outline panel. Subsequently, the user may move the cursor to a particular place in the outline panel to trigger generation of one or more suggestions for a new outline item at a particular outline level that corresponds to the cursor position. Additionally or alternatively, the user may use a short-key for opening the outline panel and initiating the one or more new outline item suggestions. In some aspects, the user may provide one or more outline items in the outline panel. It should be appreciated that, in some aspects, the productivity application 130 may extract the user intent from speech or voice of the user.

In response, at 208, the productivity application 130 generates one or more suggestions for a new outline item based on the initial text and any existing outline items using one or more semantic language models (e.g., a semantic embedding model, a generative large language model, a machine-learning model, etc.).

At 210, the productivity application 130 provides the one or more new outline item suggestions at the appropriate place in the outline panel on a graphical user interface of the user's computing device (e.g., 120) that is running the productivity application 130. It should be appreciated that the one or more new outline item suggestions may be identified (e.g., shown in a different color or highlight) in the outline panel.

At 212, the productivity application 130 receives a user selection of a new outline item suggestion from the one or more new outline item suggestions. In other words, the user is vetting each new outline suggestion to select a new outline item to be added to the outline of the document. In some aspects, the user may further modify the selected new outline. At 214, the productivity application 130 updates the outline to add the new outline item from the selected new outline item suggestion.

Subsequently, at 216 of FIG. 2B, the productivity application 130 determines if there are any existing outline items preceding or succeeding the new outline item. If the productivity application 130 determines that there are no existing outline items at 218, the method 200 skips ahead to operation 232 to automatically generate one or more suggestions for a next new outline item succeeding the new outline item based on the updated outline and any existing text.

If, however, the productivity application 130 determines that there are one or more existing outline items at 218, the method 200 advances to operation 220 to determine if there are any suggestions for modifying the one or more existing outline items based on the addition of the new outline item to improve the overall quality of the outline. It should be appreciated that not all existing outline items may require modifications based on the addition of the new outline item.

If the productivity application 130 determines that there are no suggested modifications for any of the existing outline items, the method 200 advances to skips ahead to operation 232 to automatically generate one or more suggestions for a next new outline item succeeding the new outline item based on the updated outline and any existing text.

If, however, the productivity application 130 determines that there are suggested modifications for the one or more existing outline items, the method 200 advances to operation 224 to generate suggested modifications based on the new outline item using one or more semantic language models (e.g., a semantic embedding model, a generative large language model, a machine-learning model, etc.). For example, the suggested modifications may include deletion of one or more existing outline items, rearrangement of the existing outline items, one or more edits to the existing outline items, and/or addition of one or more new outline items.

Subsequently, at 226 of FIG. 2C, the productivity application 130 provides the suggested modifications for each of the applicable existing outline items at the appropriate place in the outline panel. For example, the productivity application 130 may show all the suggested modifications to the existing outline items with track changes in the outline panel. The user may review and vet each of the suggested modifications.

At 228, the productivity application 130 receives an acceptance of the one or more suggested modifications for the applicable existing outline items from the user. In some aspects, the productivity application 130 may sequentially present the suggested modifications for each of the applicable existing outline items. In such aspects, the productivity application 130 may receive a selection from the user in response to presenting the suggested modifications for each of the applicable existing outline items. In other words, the user is vetting each suggested modification to the existing outline items. Subsequently, at 230, the productivity application 130 updates the one or more applicable existing outline items to reflect the suggested modifications accepted by the user.

At 232, the productivity application 130 automatically generates one or more suggestions for a next new outline item succeeding the new outline item based on the updated outline and the existing text in the document. Subsequently, the method 200 loops back to operation 210 of FIG. 2A to provide the next new outline item suggestions to the user in the corresponding place in the outline.

Although it is not shown in the method 200, the method 200 may end after updating the outline to include new and/or modified outline items if the productivity application 130 determines that a complete or final outline has been created. Additionally or alternatively, the method 200 may end when the productivity application 130 receives an indication from the user to end. Additionally, in some aspects, the user may reject one or more new outline item suggestions and/or one or more suggested modifications to the existing outline items. In such aspects, the method 200 may end or skip ahead to generate a next new outline item.

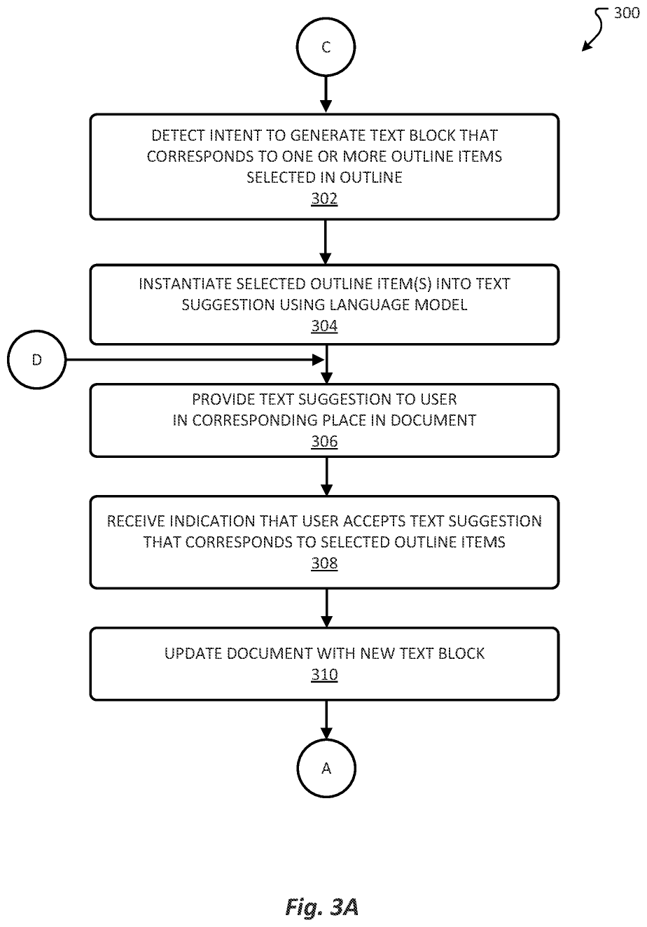

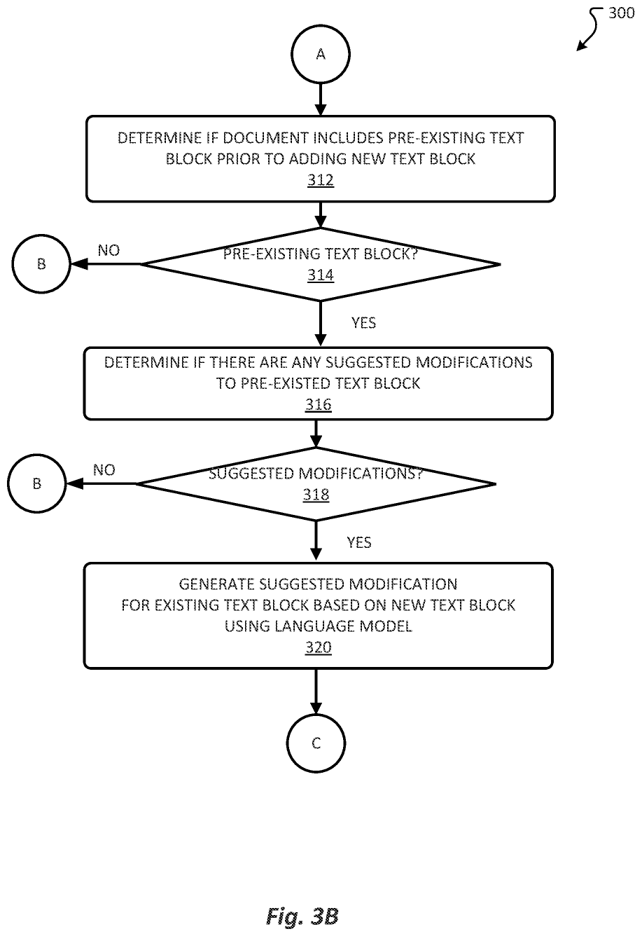

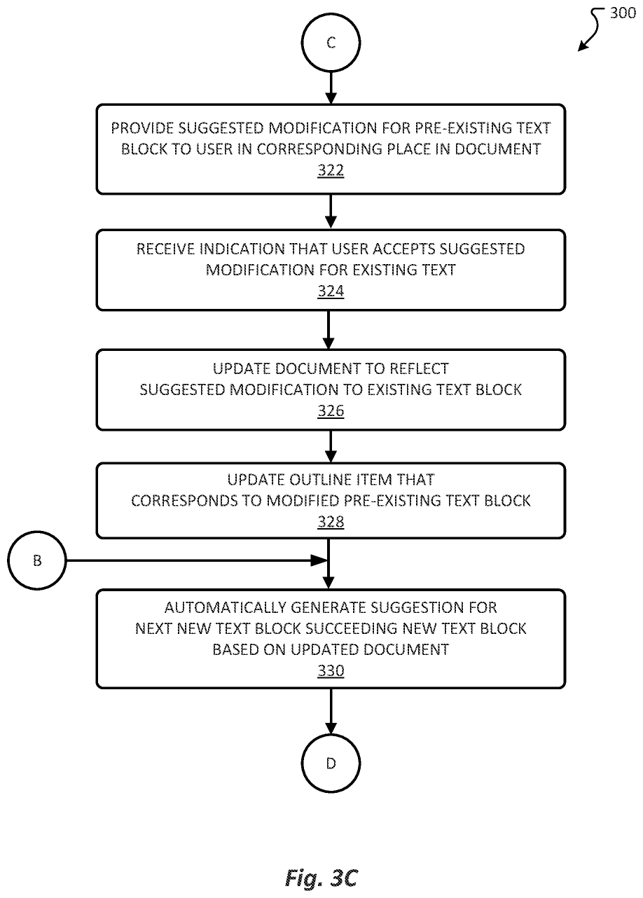

Referring now to FIGS. 3A-3C, a method 300 for generating text suggestions that correspond to one or more outline items in accordance with examples of the present disclosure is provided. A general order for the steps of the method 300 is shown in FIGS. 3A-3C. Generally, the method 300 starts at 302. The method 300 may include more or fewer steps or may arrange the order of the steps differently than those shown in FIGS. 3A-3C. In the illustrative aspect, the method 300 is performed by a computing device (e.g., a user device 120) of a user 100. However, it should be appreciated that one or more steps of the method 300 may be performed by another device (e.g., a server 160).

Specifically, in some aspects, the method 300 may be performed by a productivity application (e.g., 130) executed on the user device 120. For example, the productivity application 130 may be Microsoft® Word® or any other productivity application executed on the computing device 120. More specifically, the method 300 may be performed by a concept-level text editing tool (e.g., 132) of a productivity application (e.g., 130) executed on the user device 120. For example, the computing device 120 may be, but is not limited to, a computer, a notebook, a laptop, a mobile device, a smartphone, a tablet, wearable, or any other suitable computing device that is capable of executing a productivity application (e.g., 130). For example, the server 160 may be any suitable computing device that is capable of communicating with the computing device 120. The method 300 can be executed as a set of computer-executable instructions executed by a computer system and encoded or stored on a computer readable medium. Further, the method 300 can be performed by gates or circuits associated with a processor, Application Specific Integrated Circuit (ASIC), a field programmable gate array (FPGA), a system on chip (SOC), or other hardware device. Hereinafter, the method 300 shall be explained with reference to the systems, components, modules, software, data structures, user interfaces, etc. described in conjunction with FIG. 1 and FIGS. 7-10.

The method 300 starts at 302, where the productivity application 130 detects a user intent to generate a text block in a document that corresponds to one or more outline items selected in an outline. The text block may include one or more sentences or one or more paragraphs. To do so, the productivity application 130 may detect movement of a cursor between an outline panel and a text panel to determine which outline item(s) the user intent to instantiate into text in a document. For example, when the user moves the cursor from the outline panel to the text panel and back to a particular outline item in the outline panel, the productivity application 130 may determine that the user intends to generate a text block that corresponds to the particular outline item. In some aspects, the user may select multiple outline items and move the cursor over the selected multiple outline items to trigger generation of a text suggestion for the selected multiple outline items. Additionally or alternatively, the user may use a short-key for generating the text suggestions. It should be appreciated that, in some aspects, the productivity application 130 may extract the user intent from speech or voice of the user.

At 304, the productivity application 130 instantiates the one or more selected outline items into a text suggestion using one or more semantic language models (e.g., a semantic embedding model, a generative large language model, a machine-learning model, etc.). The text suggestion may be one or more sentences or one or more paragraphs. For example, when the user moves the cursor from the outline panel to the text panel and back to a particular outline item in the outline panel, the productivity application 130 may provide a text suggestion based on where the cursor falls in the outline. In some aspects, the user may select multiple outline items and move the cursor over the selected multiple outline items, and the productivity application 130 may provide a text suggestion for the selected multiple outline items based on where the cursor falls in the outline.

At 306, the productivity application 130 provides the text suggestion to the user at the appropriate place in the text panel on a graphical user interface of the user's computing device (e.g., 120) that is running the productivity application 130. It should be appreciated that the one or more outline items that correspond to the text suggestion may be identified (e.g., shown in a different color or highlight) in the outline panel while the text suggestion is being presented to the user. Likewise, it should be appreciated that if the user moves a cursor to a particular outline item in the outline panel, the corresponding text block may be identified (e.g., shown in a different color or highlight) in the text panel.

At 308, the productivity application 130 receives an indication that the user accepts the text suggestion that corresponds to the one or more selected outline items. It should be appreciated that, in some aspects, the productivity application 130 may provide multiple text suggestions for the selected outline item(s) at operation 306. In such aspects, the user may select a text suggestion from the multiple text suggestions to be written in the document. At 310, the productivity application 130 updates the document to add the new text block from the new text suggestion accepted or selected by the user.

Subsequently, at 312 of FIG. 3B, the productivity application 130 determines if the document included any pre-existing text blocks prior to adding the new text block. If the productivity application 130 determines that there are no pre-existing text blocks at 314, the method 300 skips ahead to operation 330 to automatically generate a next new text block succeeding the new text block based on the updated document.

If, however, the productivity application 130 determines that there is one or more pre-existing text blocks at 314, the method 300 advances to operation 316. At 316, the productivity application 130 determines if there are any suggested modifications to the one or more pre-existing text blocks. If the productivity application 130 determines that there are no suggested modifications for any of the pre-existing text blocks, the method 300 advances to skips ahead to operation 330 to automatically generate a next new text block succeeding the new text block based on the updated document.

If, however, the productivity application 130 determines that there are suggested modifications for the one or more pre-existing text blocks, the method 300 advances to operation 320 to generate suggested modifications for the applicable existing text blocks based on the new text block using one or more semantic language models (e.g., a semantic embedding model, a generative large language model, a machine-learning model, etc.). For example, the suggested modifications may include deletion of one or more existing text blocks, rearrangement of the existing text blocks, one or more edits to the existing text blocks, and/or addition of one or more new text blocks.

Subsequently, at 322 of FIG. 3C, the productivity application 130 provides the suggested modifications for each of the applicable pre-existing text blocks at the appropriate place in the text panel. For example, the productivity application 130 may show all the suggested modifications to the pre-existing text blocks with track changes in the text panel. The user may review and vet each of the suggested modifications. In some aspects, the productivity application 130 may provide multiple text suggestions for each of the applicable pre-existing text blocks at operation 322. In such aspects, the productivity application 130 may sequentially present the suggested modifications for each applicable pre-existing text block.

At 324, the productivity application 130 receives an acceptance of the one or more suggested modifications for the applicable pre-existing text blocks from the user. As described above, in some aspects, if the multiple text suggestions have been generated for each of the applicable pre-existing text blocks, the productivity application 130 may receive a selection from the user in response to sequentially presenting the suggested modifications for each of the applicable pre-existing text blocks. It should be appreciated that, regardless of how the suggested modifications are provided to the user, the user is vetting each suggested modification to the pre-existing text blocks. Subsequently, at 326, the productivity application 130 updates the one or more applicable pre-existing text blocks to reflect the suggested modifications accepted by the user.

At 328, the productivity application 130 further updates one or more outline items that corresponds to the one or more modified pre-existing text blocks. It should be appreciated that not all modified pre-existing text blocks may require the corresponding outline items to be updated based on the modifications. Although it is not shown in the method 300, the modification to the corresponding outline items is also carefully monitored and vetted by the user.

At 330, the productivity application 130 automatically generates a suggestion for a next new text block succeeding the new text based on the updated text and outline. Subsequently, the method 300 loops back to operation 306 of FIG. 3A to provide the next new text block suggestions in the corresponding place in the document to the user.

Although it is not shown in the method 300, the method 300 may end after updating the document to include new and/or modified text block if the productivity application 130 determines that a complete or final document has been created based on the outline. Additionally or alternatively, the method 300 may end when the productivity application 130 receives an indication from the user to end. Additionally, in some aspects, the user may reject one or more new text suggestions and/or one or more suggested modifications to the pre-existing text blocks. In such aspects, the method 300 may end or skip ahead to generate a next new text block.

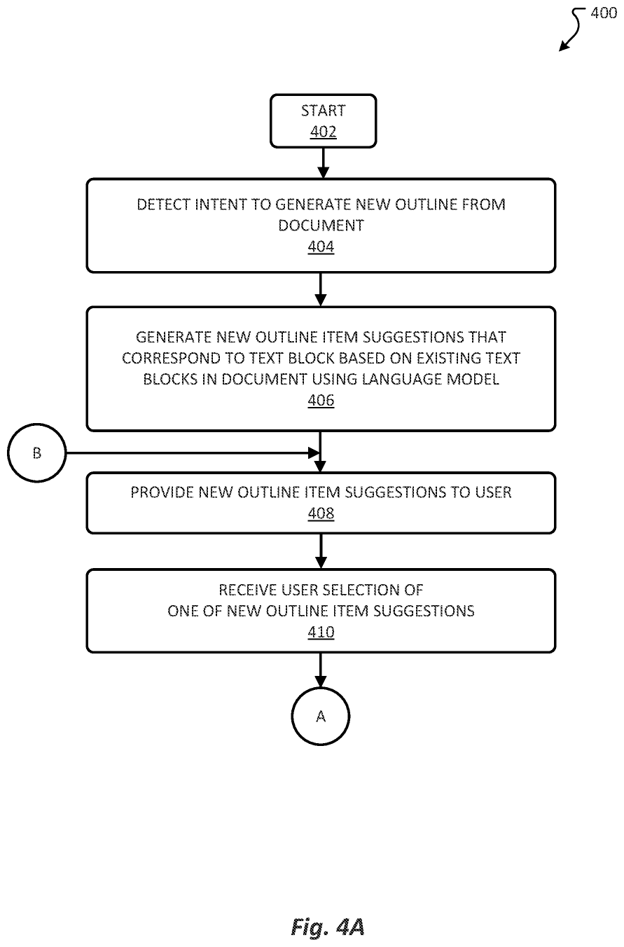

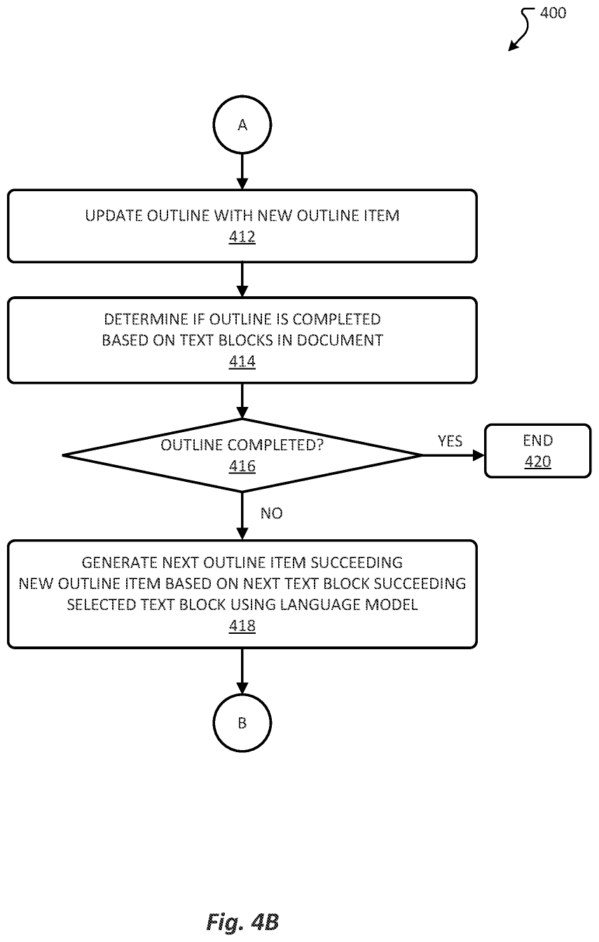

Referring now to FIGS. 4A and 4B, a method 400 for generating outline item suggestions that correspond to one or more text blocks in a document in accordance with examples of the present disclosure is provided. A general order for the steps of the method 400 is shown in FIGS. 4A and 4B. Generally, the method 400 starts at 402 and ends at 420. The method 400 may include more or fewer steps or may arrange the order of the steps differently than those shown in FIGS. 4A and 4B. In the illustrative aspect, the method 400 is performed by a computing device (e.g., a user device 120) of a user 100. However, it should be appreciated that one or more steps of the method 400 may be performed by another device (e.g., a server 160).

Specifically, in some aspects, the method 400 may be performed by a productivity application (e.g., 130) executed on the user device 120. For example, the productivity application 130 may be Microsoft® Word® or any other productivity application executed on the computing device 120. More specifically, the method 400 may be performed by a concept-level text editing tool (e.g., 132) of a productivity application (e.g., 130) executed on the user device 120. For example, the computing device 120 may be, but is not limited to, a computer, a notebook, a laptop, a mobile device, a smartphone, a tablet, wearable, or any other suitable computing device that is capable of executing a productivity application (e.g., 130). For example, the server 160 may be any suitable computing device that is capable of communicating with the computing device 120. The method 400 can be executed as a set of computer-executable instructions executed by a computer system and encoded or stored on a computer readable medium. Further, the method 400 can be performed by gates or circuits associated with a processor, Application Specific Integrated Circuit (ASIC), a field programmable gate array (FPGA), a system on chip (SOC), or other hardware device. Hereinafter, the method 400 shall be explained with reference to the systems, components, modules, software, data structures, user interfaces, etc. described in conjunction with FIG. 1 and FIGS. 7-10.

The method 400 starts at 402, where flow may proceed to 404. At 404, the productivity application 130 detects a user intent to generate a new outline from an existing document. The document includes one or more text blocks, where each text block may be one or more sentences or one or more paragraphs that the productivity application 130 processes to generate a new outline item. It should be appreciated that, in some aspects, the user may request to generate an outline based on a part of the existing document by selecting one or more text blocks in the existing document.

At 406, the productivity application 130 generates new outline item suggestions that correspond to the text block based on the existing text blocks in the document using one or more semantic language models (e.g., a semantic embedding model, a generative large language model, a machine-learning model, etc.).

At 408, the productivity application 130 provides the one or more new outline item suggestions at the appropriate place in the outline panel on a graphical user interface of the user's computing device (e.g., 120) that is running the productivity application 130. It should be appreciated that the text block that corresponds to the outline item suggestions may be identified (e.g., shown in a different color or highlight) in the text panel when the outline item suggestions are presented to the user. Likewise, it should be appreciated that if the user moves a cursor to a particular text block in the document, the corresponding outline item is identified (e.g., shown in a different color or highlight) in the outline panel.

At 410, the productivity application 130 receives a user selection of a new outline item suggestion from the one or more new outline item suggestions. In other words, the user is vetting each new outline suggestion to select a new outline item to be added to the outline of the document. In some aspects, the user may further modify the selected new outline item suggestion. Subsequently, at 412 of FIG. 4B, the productivity application 130 updates the outline to add the new outline item from the selected new outline item suggestion.

At 414, the productivity application 130 determines if the outline is completed based on the text blocks in the document. For example, the productivity application 130 determines if outline items have been generated for all the text blocks in the document. In other words, the productivity application 130 determines if the updated outline represents all the text blocks in the document. If the productivity application 130 determines that the outline is complete at 416, the method 400 may end at 420.

If, however, the productivity application 130 determines that the outline is incomplete at 416, the method 400 advances to operation 418. At 418, the productivity application 130 generates a next outline item succeeding the new outline item using one or more semantic language models (e.g., a semantic embedding model, a generative large language model, a machine-learning model, etc.). Subsequently, the method 400 loops back to operation 408 of FIG. 4A to provide the next new outline item suggestions to the user in the corresponding place in the outline. As described above, the productivity application 130 may continue generating a next outline item until the outline is complete.

It should be appreciated that, in some aspects, the productivity application 130 may receive a document and generate a new complete outline. In such aspects, the productivity application 130 may allow the user to vet each outline item of the new complete outline. Additionally, although it is not shown in the method 400, the method 400 may end when the productivity application 130 receives an indication from the user to end. It should be appreciated that, in some aspects, the user may reject one or more new text suggestions and/or one or more suggested modifications to the pre-existing text blocks. In such aspects, the method 400 may end or skip ahead to generate a next new text block.

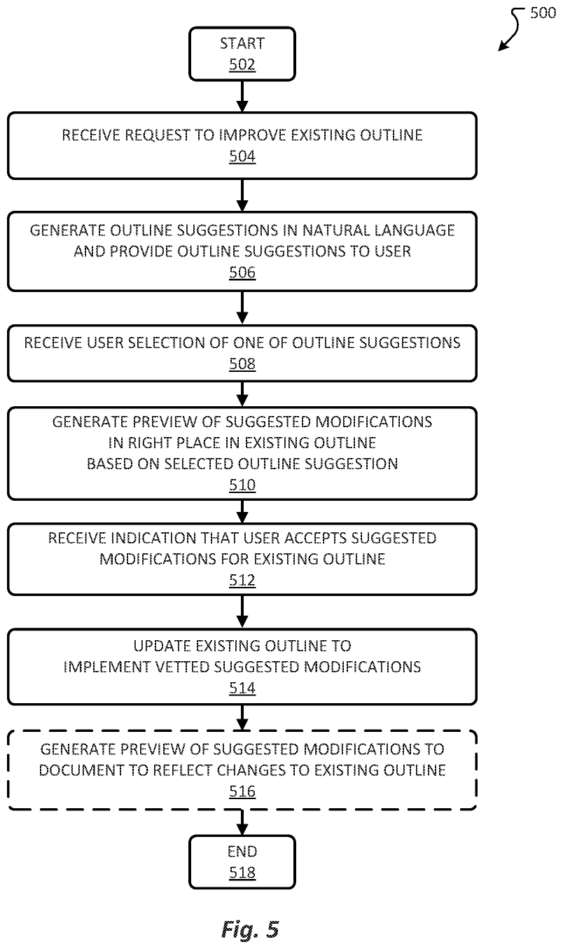

Referring now to FIG. 5, a method 500 for generating outline suggestions for improving an existing outline in accordance with examples of the present disclosure is provided. A general order for the steps of the method 500 is shown in FIG. 5. Generally, the method 500 starts at 502 and ends at 518. The method 500 may include more or fewer steps or may arrange the order of the steps differently than those shown in FIG. 5. In the illustrative aspect, the method 500 is performed by a computing device (e.g., a user device 120) of a user 100. However, it should be appreciated that one or more steps of the method 500 may be performed by another device (e.g., a server 160).

Specifically, in some aspects, the method 500 may be performed by a productivity application (e.g., 130) executed on the user device 120. For example, the productivity application 130 may be Microsoft® Word® or any other productivity application executed on the computing device 120. More specifically, the method 500 may be performed by a concept-level text editing tool (e.g., 132) of a productivity application (e.g., 130) executed on the user device 120. For example, the computing device 120 may be, but is not limited to, a computer, a notebook, a laptop, a mobile device, a smartphone, a tablet, wearable, or any other suitable computing device that is capable of executing a productivity application (e.g., 130). For example, the server 160 may be any suitable computing device that is capable of communicating with the computing device 120. The method 500 can be executed as a set of computer-executable instructions executed by a computer system and encoded or stored on a computer readable medium. Further, the method 500 can be performed by gates or circuits associated with a processor, Application Specific Integrated Circuit (ASIC), a field programmable gate array (FPGA), a system on chip (SOC), or other hardware device. Hereinafter, the method 500 shall be explained with reference to the systems, components, modules, software, data structures, user interfaces, etc. described in conjunction with FIG. 1 and FIGS. 7-10.

The method 500 starts at 502, where flow may proceed to 504. At 504, the productivity application 130 detects a request from user to improve an existing outline. As described above, the outline includes a plurality of outline items. It should be appreciated that, in some aspects, the user may request to improve a part of the existing outline by selecting one or more outline items in the existing outline. In some aspect, the user may request to shorten or expand the existing outline. It should be appreciated that, in some aspects, the productivity application 130 may extract the user request from speech or voice of the user.

Subsequently, at 506, the productivity application 130 generates one or more outline suggestions in natural language based on the existing outline using one or more semantic language models (e.g., a semantic embedding model, a generative large language model, a machine-learning model, etc.). Specifically, the outline suggestions describe how to improve the existing outline in natural language without showing actual suggested modifications to the existing outline. For example, the outline suggestions may include “use more active verbs” or “add a call to action to the end.” The productivity application 130 provides the one or more natural language outline suggestions to the user.

At 508, the productivity application 130 receives a user selection of one of the natural language outline suggestions. Subsequently, at 510, the productivity application 130 generates a preview of suggested modifications to the existing outline at the appropriate place in an outline panel based on the selected outline suggestion. For example, the suggested modifications may include addition of one or more new outline items, deletion of one or more existing outline items, rearrangement of the existing outline items, and one or more edits to the existing outline items. Additionally, the productivity application 130 may provide all the suggested modifications to the existing outline with track changes in the outline panel. The user may review and vet each of the suggested modifications.

At 512, the productivity application 130 receives an indication that the user accepts the one or more suggested modifications to the existing outline. Subsequently, at 514, the productivity application 130 updates the existing outline to implement the one or more suggested modifications vetted by the user.

It should be appreciated that, in some aspects, there may be an existing document that corresponds to the existing outline. In such aspects, at 516, the productivity application 130 may generate a preview of suggested modifications to the existing document to reflect changes to the existing outline. Although it is not shown in the method 500, the user may review and vet each of the suggested modifications to the existing document. The method 500 may end at 518.

Although it is not shown in the method 500, the method 500 may loop back to operation 506 to continue generating one or more natural language outline suggestions based on the updated existing outline. Additionally, the method 500 may end when the productivity application 130 determines that there are no further outline suggestions for improving the updated existing outline. Additionally or alternatively, the method 500 may end when the productivity application 130 receives an indication from the user to end. Additionally, in some aspects, the user may reject one or more suggested modifications to the existing outline items and/or the existing text.

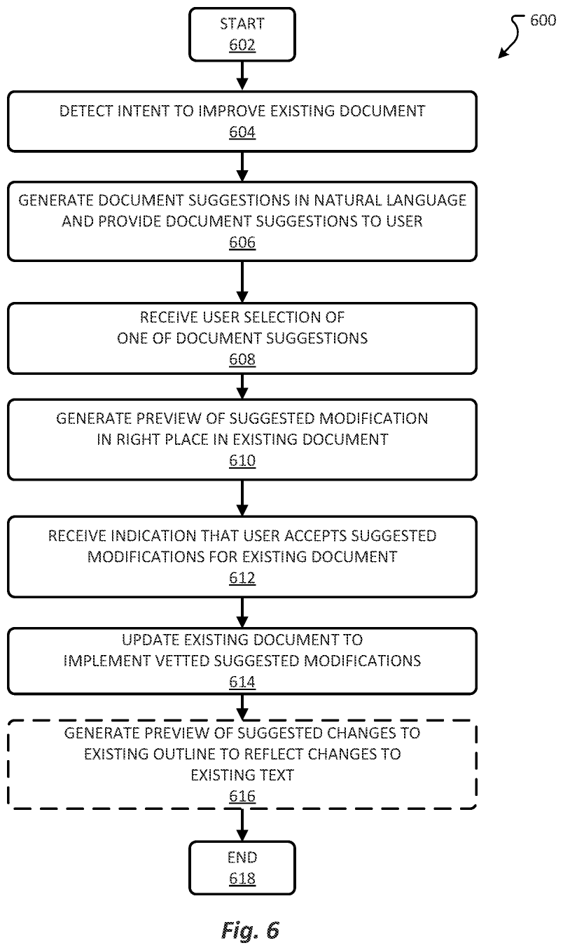

Referring now to FIG. 6, method 600 for generating suggestions for improving an existing document in accordance with examples of the present disclosure is provided. A general order for the steps of the method 600 is shown in FIG. 6. Generally, the method 600 starts at 602 and ends at 616. The method 600 may include more or fewer steps or may arrange the order of the steps differently than those shown in FIG. 6. In the illustrative aspect, the method 600 is performed by a computing device (e.g., a user device 120) of a user 100. However, it should be appreciated that one or more steps of the method 600 may be performed by another device (e.g., a server 160).

Specifically, in some aspects, the method 600 may be performed by a productivity application (e.g., 130) executed on the user device 120. For example, the productivity application 130 may be Microsoft® Word® or any other productivity application executed on the computing device 120. More specifically, the method 600 may be performed by a concept-level text editing tool (e.g., 132) of a productivity application (e.g., 130) executed on the user device 120. For example, the computing device 120 may be, but is not limited to, a computer, a notebook, a laptop, a mobile device, a smartphone, a tablet, wearable, or any other suitable computing device that is capable of executing a productivity application (e.g., 130). For example, the server 160 may be any suitable computing device that is capable of communicating with the computing device 120. The method 600 can be executed as a set of computer-executable instructions executed by a computer system and encoded or stored on a computer readable medium. Further, the method 600 can be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIG. 1 and FIGS. 7-10.

The method 600 starts at 602, where flow may proceed to 604. At 604, the productivity application 130 detects a request from user to improve an existing document. As described above, the document includes a plurality of text blocks, and the text blocks may include one or more sentences or one or more paragraphs. It should be appreciated that, in some aspects, the user may request to improve a part of the existing document by selecting one or more text blocks in the existing document. In some aspect, the user may request to shorten or expand the existing document. It should be appreciated that, in some aspects, the productivity application 130 may extract the user request from speech or voice of the user.

Subsequently, at 606, the productivity application 130 generates one or more document suggestions in natural language based on the existing document using one or more semantic language models (e.g., a semantic embedding model, a generative large language model, a machine-learning model, etc.). Specifically, the document suggestions describe how to improve the existing document in natural language without showing actual suggested modifications to the existing document. For example, the document suggestions may include “use more active verbs” or “vary sentence lengths to create a more engaging rhythm.” The productivity application 130 provides the one or more natural language document suggestions to the user.

At 608, the productivity application 130 receives a user selection of one of the natural language document suggestions. Subsequently, at 610, the productivity application 130 generates a preview of suggested modifications to the existing document at the appropriate place in a text panel based on the selected document suggestion. For example, the suggested modifications may include addition of one or more new text blocks, deletion of one or more existing text blocks, rearrangement of the existing text blocks, and one or more edits to the existing text blocks. Additionally, the productivity application 130 may provide all the suggested modifications to the existing document with track changes in the text panel. The user may review and vet each of the suggested modifications.

At 612, the productivity application 130 receives an indication that the user accepts the one or more suggested modifications to the existing document. Subsequently, at 614, the productivity application 130 updates the existing document to implement the one or more suggested modifications vetted by the user.

It should be appreciated that, in some aspects, there may be an existing outline that corresponds to the existing document. In such aspects, at 616, the productivity application 130 may generate a preview of suggested modifications to the existing outline to reflect changes to the existing document. Although it is not shown in the method 600, the user may review and vet each of the suggested modifications to the existing outline. The method 600 may end at 618.

Although it is not shown in the method 600, the method 600 may loop back to operation 606 to continue generating one or more natural language document suggestions based on the updated existing document. Additionally, the method 600 may end when the productivity application 130 determines that there are no further document suggestions for improving the document. Additionally, or alternatively, the method 600 may end when the productivity application 130 receives an indication from the user to end. Additionally, in some aspects, the user may reject one or more suggested modifications to the existing document and/or the existing outline.

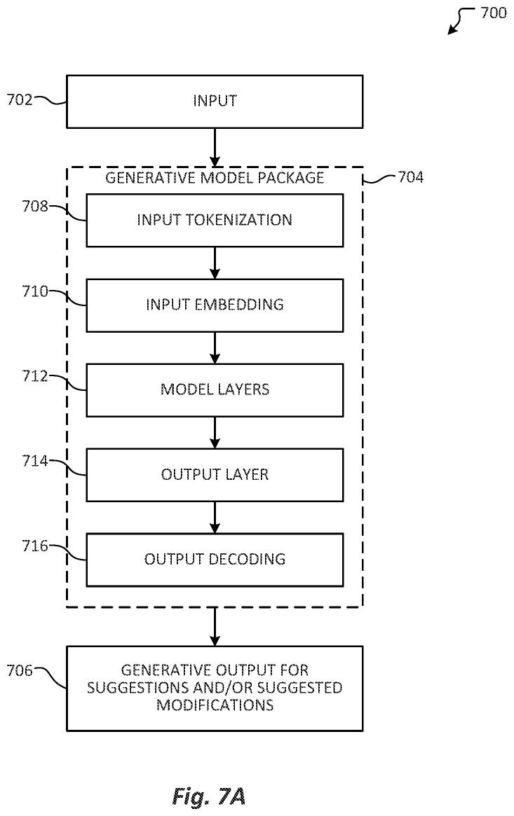

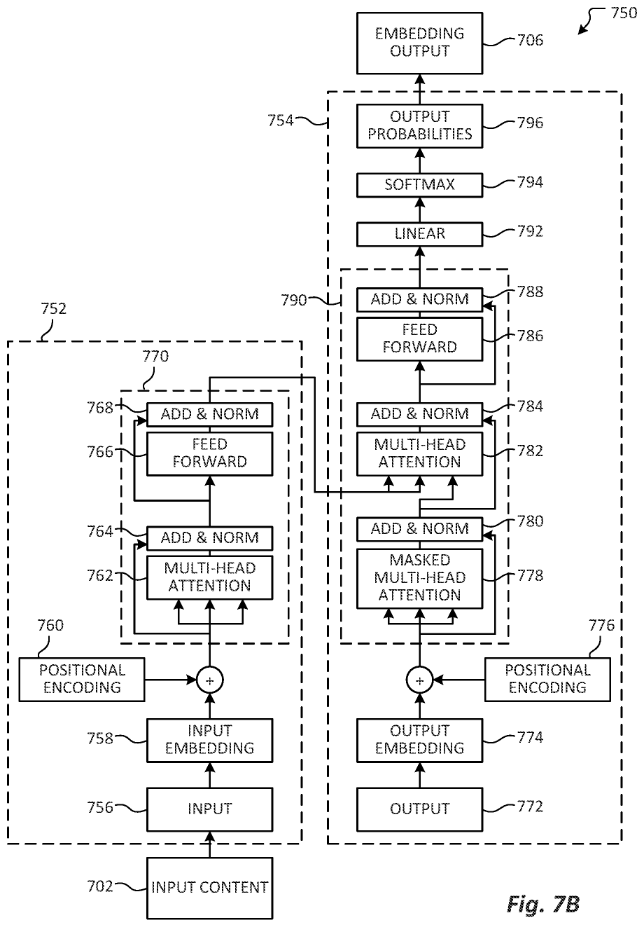

FIGS. 7A and 7B illustrate overviews of an example generative machine learning model that may be used according to aspects described herein. With reference first to FIG. 7A, conceptual diagram 700 depicts an overview of pre-trained generative model package 704 that processes an input 702 to generate model output for storing entries in and/or retrieving information from a generative model output 706 (e.g., suggestions and/or suggested modifications) according to aspects described herein. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 704 is pre-trained according to a variety of inputs (e.g., a variety of human languages, a variety of programming languages, and/or a variety of content types) and therefore need not be finetuned or trained for a specific scenario. Rather, generative model package 704 may be more generally pre-trained, such that input 702 includes a prompt that is generated, selected, or otherwise engineered to induce generative model package 704 to produce certain generative model output 706. It will be appreciated that input 702 and generative model output 706 may each include any of a variety of content types, including, but not limited to, text output, image output, audio output, video output, programmatic output, and/or binary output, among other examples. In examples, input 702 and generative model output 706 may have different content types, as may be the case when generative model package 704 includes a generative multimodal machine learning model.

As such, generative model package 704 may be used in any of a variety of scenarios and, further, a different generative model package may be used in place of generative model package 704 without substantially modifying other associated aspects (e.g., similar to those described herein with respect to FIGS. 1-7). Accordingly, generative model package 704 operates as a tool with which machine learning processing is performed, in which certain inputs 702 to generative model package 704 are programmatically generated or otherwise determined, thereby causing generative model package 704 to produce model output 706 that may subsequently be used for further processing.

Generative model package 704 may be provided or otherwise used according to any of a variety of paradigms. For example, generative model package 704 may be used local to a computing device (e.g., computing device 140 in FIG. 1) or may be accessed remotely from a machine learning service (e.g., productivity platform server 160 in FIG. 1). In other examples, aspects of generative model package 704 are distributed across multiple computing devices. In some instances, generative model package 704 is accessible via an application programming interface (API), as may be provided by an operating system of the computing device and/or by the machine learning service, among other examples.

With reference now to the illustrated aspects of generative model package 704, generative model package 704 includes input tokenization 708, input embedding 710, model layers 712, output layer 714, and output decoding 716. In examples, input tokenization 708 processes input 702 to generate input embedding 710, which includes a sequence of symbol representations that corresponds to input 702. Accordingly, input embedding 710 is processed by model layers 712, output layer 714, and output decoding 716 to produce model output 706. An example architecture corresponding to generative model package 704 is depicted in FIG. 7B, which is discussed below in further detail. Even so, it will be appreciated that the architectures that are illustrated and described herein are not to be taken in a limiting sense and, in other examples, any of a variety of other architectures may be used.

FIG. 7B is a conceptual diagram that depicts an example architecture 750 of a pre-trained generative machine learning model that may be used according to aspects described herein. As noted above, any of a variety of alternative architectures and corresponding ML models may be used in other examples without departing from the aspects described herein.

As illustrated, architecture 750 processes input 702 to produce generative model output 706, aspects of which were discussed above with respect to FIG. 7A. Architecture 750 is depicted as a transformer model that includes encoder 752 and decoder 754. Encoder 752 processes input embedding 758 (aspects of which may be similar to input embedding 710 in FIG. 7A), which includes a sequence of symbol representations that corresponds to input 756. In examples, input 756 includes input content 702 corresponding to a type of content, aspects of which may be similar to any inputs, requests, document, outline, text blocks, and/or outline items.

Further, positional encoding 760 may introduce information about the relative and/or absolute position for tokens of input embedding 758. Similarly, output embedding 774 includes a sequence of symbol representations that correspond to output 772, while positional encoding 776 may similarly introduce information about the relative and/or absolute position for tokens of output embedding 774.

As illustrated, encoder 752 includes example layer 770. It will be appreciated that any number of such layers may be used, and that the depicted architecture is simplified for illustrative purposes. Example layer 770 includes two sub-layers: multi-head attention layer 762 and feed forward layer 766. In examples, a residual connection is included around each layer 762, 766, after which normalization layers 764 and 768, respectively, are included.

Decoder 754 includes example layer 790. Similar to encoder 752, any number of such layers may be used in other examples, and the depicted architecture of decoder 754 is simplified for illustrative purposes. As illustrated, example layer 790 includes three sub-layers: masked multi-head attention layer 778, multi-head attention layer 782, and feed forward layer 786. Aspects of multi-head attention layer 782 and feed forward layer 786 may be similar to those discussed above with respect to multi-head attention layer 762 and feed forward layer 766, respectively. Additionally, masked multi-head attention layer 778 performs multi-head attention over the output of encoder 752 (e.g., output 772). In examples, masked multi-head attention layer 778 prevents positions from attending to subsequent positions. Such masking, combined with offsetting the embeddings (e.g., by one position, as illustrated by multi-head attention layer 782), may ensure that a prediction for a given position depends on known output for one or more positions that are less than the given position. As illustrated, residual connections are also included around layers 778, 782, and 786, after which normalization layers 780, 784, and 788, respectively, are included.

Multi-head attention layers 762, 778, and 782 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 7B (e.g., by a corresponding normalization layer 764, 780, or 784).

Feed forward layers 766 and 786 may each be a fully connected feed-forward network, which applies to each position. In examples, feed forward layers 766 and 786 each include a plurality of linear transformations with a rectified linear unit activation in between. In examples, each linear transformation is the same across different positions, while different parameters may be used as compared to other linear transformations of the feed-forward network.

Additionally, aspects of linear transformation 792 may be similar to the linear transformations discussed above with respect to multi-head attention layers 762, 778, and 782, as well as feed forward layers 766 and 786. Softmax 794 may further convert the output of linear transformation 792 to predicted next-token probabilities, as indicated by output probabilities 796. It will be appreciated that the illustrated architecture is provided in as an example and, in other examples, any of a variety of other model architectures may be used in accordance with the disclosed aspects.

Accordingly, output probabilities 796 may thus form generative model output 706 according to aspects described herein, such that the output of the generative ML model (e.g., which may include structured output) is used as input for a determining an action according to aspects described herein. In other examples, generative model output 706 is provided as generated output for updating a document and/or a document outline.

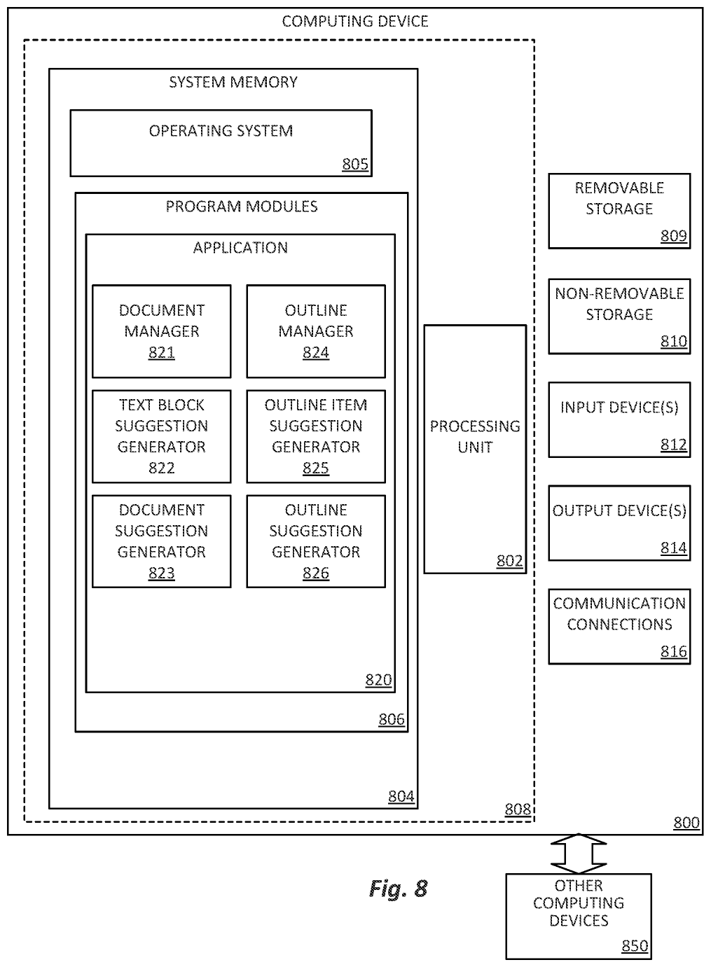

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of computing device configurations that may be utilized for practicing aspects of the disclosure, described herein.

FIG. 8 is a block diagram illustrating physical components (e.g., hardware) of a computing device 800 with which aspects of the disclosure may be practiced. The computing device components described below may be suitable for the computing devices described above, including one or more devices associated with machine learning service (e.g., productive platform server 160), as well as computing device 140 discussed above with respect to FIG. 1. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories.

The system memory 804 may include an operating system 805 and one or more program modules 806 suitable for running software application 820, such as one or more components supported by the systems described herein. As examples, system memory 804 may store a document manager 821, a text suggestion generator 822, a document improvement suggester 823, an outline manager 824, an outline item suggestion generator 825, and/or an outline improvement suggester 826. The operating system 805, for example, may be suitable for controlling the operation of the computing device 800.

Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., application 820) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

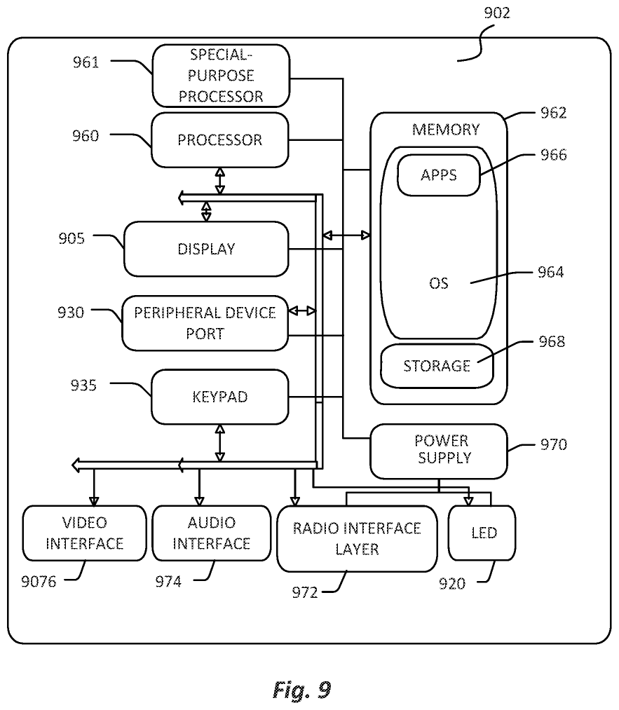

FIG. 9 illustrates a system 900 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 900 is implemented as a “smart phone” capable of running one or more applications (e.g., browser, e-mail, calendaring, contact managers, messaging clients, games, and media clients/players). In some aspects, the system 900 is integrated as a computing device, such as an integrated personal digital assistant (PDA) and wireless phone.

In a basic configuration, such a mobile computing device is a handheld computer having both input elements and output elements. The system 900 typically includes a display 905 and one or more input buttons that allow the user to enter information into the system 900. The display 905 may also function as an input device (e.g., a touch screen display).

If included, an optional side input element allows further user input. For example, the side input element may be a rotary switch, a button, or any other type of manual input element. In alternative aspects, system 900 may incorporate more or less input elements. For example, the display 905 may not be a touch screen in some embodiments. In another example, an optional keypad 935 may also be included, which may be a physical keypad or a “soft” keypad generated on the touch screen display.

In various embodiments, the output elements include the display 905 for showing a graphical user interface (GUI), a visual indicator (e.g., a light emitting diode 920), and/or an audio transducer 925 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 900 also includes a non-volatile storage area 968 within the memory 962. The non-volatile storage area 968 may be used to store persistent information that should not be lost if the system 900 is powered down. The application programs 966 may use and store information in the non-volatile storage area 968, such as e-mail or other messages used by an e-mail application, and the like. A synchronization application (not shown) also resides on the system 900 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the system 900 described herein (e.g., a document manager, a text suggestion generator, a document improvement suggester, an outline manager, an outline item suggestion generator, an outline improvement suggester, etc.).

The system 900 has a power supply 970, which may be implemented as one or more batteries. The power supply 970 might further include an external power source, such as an AC adapter or a powered docking cradle that supplements or recharges the batteries.

The system 900 may also include a radio interface layer 972 that performs the function of transmitting and receiving radio frequency communications. The radio interface layer 972 facilitates wireless connectivity between the system 900 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated embodiment, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 900 may further include a video interface 976 that enables an operation of an on-board camera 930 to record still images, video stream, and the like.

It will be appreciated that system 900 may have additional features or functionality. For example, system 900 may also include additional data storage devices (removable and/or non-removable) such as, magnetic disks, optical disks, or tape. Such additional storage is illustrated in FIG. 9 by the non-volatile storage area 968.

Data/information generated or captured and stored via the system 900 may be stored locally, as described above, or the data may be stored on any number of storage media that may be accessed by the device via the radio interface layer 972 or via a wired connection between the system 900 and a separate computing device associated with the system 900, for example, a server computer in a distributed computing network, such as the Internet. As should be appreciated, such data/information may be accessed via the radio interface layer 972 or via a distributed computing network. Similarly, such data/information may be readily transferred between computing devices for storage and use according to any of a variety of data/information transfer and storage means, including electronic mail and collaborative data/information sharing systems.

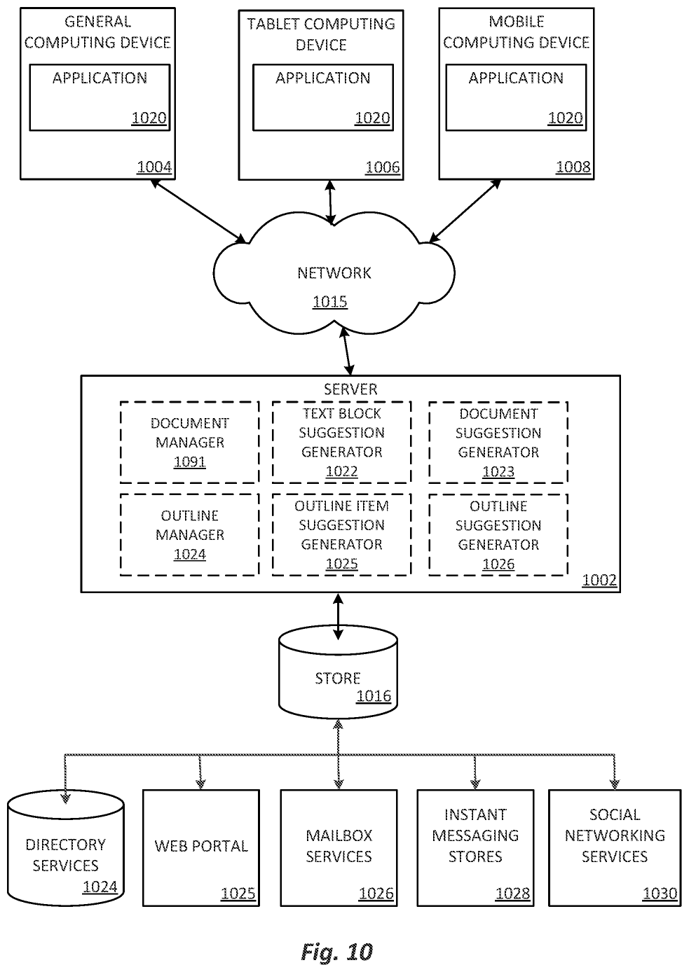

FIG. 10 illustrates one aspect of the architecture of a system for processing data received at a computing system from a remote source, such as a personal computer 1004, tablet computing device 1006, or mobile computing device 1008, as described above. Content displayed at server device 1002 may be stored in different communication channels or other storage types. For example, various documents may be stored using a directory service 1024, a web portal 1025, a mailbox service 1026, an instant messaging store 1028, or a social networking site 1030.

An application 1020 (e.g., similar to the application 820) may be employed by a client that communicates with server device 1002. Additionally, or alternatively, a document manager 1091, a text suggestion generator 1092, a document improvement suggester 1093, an outline manager 1094, an outline item suggestion generator 1095, and/or an outline improvement suggester 1096 may be employed by server device 1002. The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these examples of the computing devices may obtain content from the store 1016, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with examples of the present disclosure, a productivity application provides a concept-level text editing tool that assists users to create a document by generating suggestions of new contents (e.g., an outline or text) of the document while also improving the quality of existing contents of the document. More particularly, the present disclosure teaches the ability to generate an outline by providing step-by-step suggestions of a next outline item, generate text suggestions based on selected outline items, generate new outline item suggestions from selected text, and generate a list of natural language suggestions for an existing outline and/or existing text in the document. It should be appreciated that any implementation or modification to the document or the outline based on the suggestions is vetted by the user.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

What is claimed is:

1. A method for generating new outline item suggestions for generating an outline to be used to create a document, the method comprising:
receiving an initial text from a user in a text panel;
detecting an intent to generate a new outline item;
generating new outline item suggestions based on the initial text and any existing outline item using one or more semantic language models;
providing the new outline item suggestions to the user in an outline panel;
receiving a user selection of one of the new outline item suggestions; and
updating the outline to add the new outline item from the selected new outline item suggestion.

2. The method of claim 1, further comprising:
automatically generating next outline item suggestions for a next new outline item succeeding the new outline item based on the updated outline and any existing outline item.

3. The method of claim 1, further comprising:
determining if there is an existing outline item preceding or succeeding the new outline item;
in response to determining that there is the existing outline item, generating one or more suggested modifications for the existing outline item based on the updated outline using the one or more semantic language models;
providing the one or more suggested modifications for the existing outline item in a corresponding place in the updated outline;
receiving a user acceptance of the one or more suggested modifications; and
in response to receiving the user acceptance, updating the updated outline to reflect the accepted suggested modifications to the existing outline item.

4. The method of claim 2, wherein generating one or more suggested modifications for the existing outline item based on the updated outline includes:
in response to determining that there is the existing outline item, determining if there are suggested modifications to the existing outline item based on the updated outline; and
in response to determining that there are suggested modifications to the existing outline item, generating one or more suggested modifications for the existing outline item based on the updated outline.

5. The method of claim 2, wherein the suggested modifications include deletion of the existing outline item, rearrangement of the existing outline item, one or more edits to the existing outline item, and/or addition of one or more new outline items.

6. The method of claim 1, wherein detecting the intent to generate the new outline item includes:
detecting a position of a cursor in an outline panel to determine which outline item the user intent to generate, or
detecting a presence of a cursor in an outline panel to trigger generation of one or more new outline item suggestions for the new outline item.

7. The method of claim 1, wherein detecting the intent to generate the new outline item includes:
detecting a receipt of an associated short-key, or
extracting the intent from speech or voice of the user.

8. The method of claim 1, further comprising:
receiving context data, the context data including information related to the document, and
training the one or more semantic language models using the context data.

9. A method for generating one or more text blocks of a document based on one or more outline items of an outline, the method comprising:
detecting an intent to generate a new text block of the document that corresponds to one or more outline items selected in the outline;
instantiating the one or more selected outline items into a text suggestion using one or more semantic language models;
providing the text suggestion to the user in a corresponding place in the document;
receiving an indication that the user accepts the text suggestion; and
updating the document to add the new text block from the text suggestion.

10. The method of claim 9, further comprising:
automatically generating a next text suggestion for a next new text block succeeding the new text block based on the updated document and the outline.

11. The method of claim 9, further comprising:
determining if there is the document include an existing text block preceding or succeeding the new text block;
in response to determining that there is the existing text block, generating one or more suggested modifications for the existing text block based on the updated document using the one or more semantic language models;
providing the one or more suggested modifications for the existing text block in a corresponding place in the updated document;
receiving a user acceptance of the one or more suggested modifications; and
in response to receiving the user acceptance, updating the updated document to reflect the accepted suggested modifications to the existing text block.

12. The method of claim 11, wherein generating one or more suggested modifications for the existing text block based on the updated document includes:
in response to determining that there is the existing text block, determining if there are any suggested modifications to the existing text block based on the updated document; and
in response to determining that there are suggested modifications to the existing text block, generating one or more suggested modifications for the existing text block based on the updated document.

13. The method of claim 11, wherein the suggested modifications include deletion of the existing text blocks, rearrangement of the existing text blocks, one or more edits to the existing text blocks, and/or addition of one or more new text blocks.

14. The method of claim 9, wherein the one or more semantic language models comprise a generative large language model (LLM).

15. A method for generating new outline item generating one or more suggestions in natural language for improving an existing content, the method comprising:
receiving a user request to improve the existing content;
generating the one or more suggestions in natural language describing how to improve the existing content using one or more semantic language models;
providing the one or more suggestions to the user;
receiving a selection from the one or more suggestions;
generating a preview of suggested modifications applied to the existing content associated with the selected suggestion;
receiving an indication that the user accepts the suggested modifications; and
updating the existing content to implement the suggested modifications.

16. The method of claim 15, wherein the content is a document or an outline of a document.

17. The method of claim 15, further comprising generating a preview of suggested modifications to an outline of the content to reflect changes to the updated content, wherein the content is a document.

18. The method of claim 15, further comprising generating a preview of suggested modifications to a document related to the content to reflect changes to the updated content, wherein the content is an outline of a document.

19. The method of claim 15, wherein the suggested modifications include deletion of the existing content, rearrangement of the existing content, one or more edits to the existing content, and/or addition of one or more new content.

20. The method of claim 15, wherein the one or more semantic language models comprise a generative large language model (LLM).
